(19) United States
(12) Patent Application Publication
(10) Pub. No.: US 2015/0049598 A1
(43) Pub. Date: Feb. 19, 2015

(54) OPTICAL DISC DEVICE

(71) Applicant: Funai Electric Co., Ltd., Osaka (JP)

(72) Inventor: Hiroya FUKUDA, Daito-shi (JP)

(21) Appl. No.: 14/456,022

(22) Filed: Aug. 11, 2014

(30) Foreign Application Priority Data
Aug. 19, 2013 (JP) 2013-169462

(51) Int. Cl. G11B 20/10; G11B 7/005

(52) U.S. Cl. CPC G11B 20/10481; G11B 7/005
USPC 369/47.17

(57) ABSTRACT

An optical disc device includes an optical pickup unit which irradiates an optical disc with light and generates a signal according to light reflected from the optical disc, a playback unit which uses the signal to execute playback of the optical disc, and an adjustment unit which executes settings adjustment processing that includes a first adjustment process and a second adjustment process to adjust various settings pertaining to the playback quality of the optical disc. The adjustment unit measures a first evaluation item that serves as an indicator of whether or not it is necessary to execute the first adjustment process and a second evaluation item that serves as an indicator of whether or not it is necessary to execute the second adjustment process, omits execution of the first and second adjustment processes depending on the results of measuring the values of the first and second evaluation items, respectively.

### BACKGROUND OF THE INVENTION

1. Field of the Invention

The present invention relates to an optical disc device which performs processing that uses optical discs.

2. Description of the Related Art

Optical disc devices have been widely used in the past to perform playback or the like of optical discs. Such optical disc devices perform a series of processes to adjust various settings pertaining to optical disc playback quality (hereinafter also referred to as “settings adjustment processing”) before starting playback of the optical disc. The settings adjustment processing includes adjustment of the optical pickup device for the purpose of increasing read precision and the like.

Performing the settings adjustment processing enables the required optical disc playback quality to be ensured. However, optical disc devices may have already been in a state in which the required playback quality can be obtained even if the settings adjustment processing is still performing, for example.

In such cases, if the settings adjustment processing is configured so as to terminate at the stage where it is ascertained that the required playback quality can be obtained, then the execution of unnecessary processing can be prevented. Note that it is desirable, from the standpoint of reducing the standby time until playback as much as possible, or the like, that the optical disc device be able to identify in detail processes that are unnecessary in the settings adjustment processing and to omit the execution thereof.

### SUMMARY OF THE INVENTION

Preferred embodiments of the present invention provide an optical disc device configured to identify in detail processes that are unnecessary in settings adjustment processing and prevent the execution of the unnecessary processes.

An optical disc device according to a preferred embodiment of the present invention includes an optical pickup unit configured to irradiate an optical disc with light and generate a signal according to the reflected light from the optical disc, a playback unit configured to use the signal to execute playback of the optical disc, and an adjustment unit configured to execute settings adjustment processing that includes a first adjustment process and a second adjustment process as a series of processes to adjust various settings pertaining to the playback quality of the optical disc, wherein the adjustment unit is configured to measure, among evaluation items that are correlated to the playback quality, the respective values of a first evaluation item that is an indicator of whether or not it is necessary to execute the first adjustment process and a second evaluation item that is an indicator of whether or not it is necessary to execute the second adjustment process, omit execution of the first adjustment process depending on the result of measuring the value of the first evaluation item, and omit execution of the second adjustment process depending on the result of measuring the value of the second evaluation item.

This configuration makes it possible to identify in detail processes that are unnecessary in the settings adjustment processing and to omit the execution thereof. Note that the first adjustment process and the second adjustment process each preferably include a process to adjust at least one of the various settings. Furthermore, optical disc playback via the optical disc device is a concept that includes formats in which the optical disc device performs display or the like of playback images, as well as formats in which the optical disc device outputs signals for playback to external equipment (formats that cause external equipment to perform display or the like of playback images).

Moreover, the optical disc device may also be configured such that the adjustment unit is configured to execute the second adjustment process as part of the first adjustment process and omit measurement of the value of the second evaluation item when execution of the first adjustment process is omitted. With this configuration, the execution of wasteful processes is prevented by the extent to which measurement of the value of the second evaluation item that is unnecessary is omitted.

In addition, the optical disc device may also be configured such that the adjustment unit measures the value of the first evaluation item after performing the respective processes of the settings adjustment processing excluding the first adjustment process and the second adjustment process. This configuration makes it possible to omit execution of the first adjustment process when the first evaluation item is good after performing these processes.

Furthermore, the optical disc device may also be configured such that the adjustment unit measures the value of the first evaluation item and then determines whether or not it is necessary to execute the first adjustment process based on the results of this measurement, and when it determines that execution is not necessary, it terminates the settings adjustment processing. This configuration makes it possible to shorten the time required for the settings adjustment processing and to reduce the standby time until playback, for example, as much as possible.

Moreover, the optical disc device may also be configured such that the first evaluation item is jitter in the signal.

In addition, the optical disc device may also be configured such that the first adjustment process includes at least one process from among amplitude adjustment of the signal, equalizer adjustment of the signal, focus gain adjustment, and tracking gain adjustment.

Furthermore, the optical disc device may also be configured such that the second evaluation item is the ratio of the width of the oscillation of the signal to the peak in the absolute value of the signal.

Moreover, the optical disc device may also be configured such that the second adjustment process includes at least one process from among focus balance adjustment, beam expander adjustment, and tilt adjustment.

In addition, in an optical disc device of the configuration which executes spin-up processing that includes the settings adjustment processing, the configuration is such that the playback unit starts the playback of the optical disc upon the termination of the spin-up processing. This configuration enables optical disc playback to be started promptly and automatically.

With optical disc devices according to various preferred embodiments of the present invention, it is possible to identify in detail processes that are unnecessary in the settings adjustment processing and to omit the execution thereof.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a block diagram of an optical disc device according to a preferred embodiment of the present invention.

FIG. 2 is a configuration diagram of an optical pickup unit and its periphery.

FIG. 3 is a flowchart pertaining to the settings adjustment processing according to a first preferred embodiment of the present invention.

FIG. 4 is an explanatory diagram pertaining to MOD.

FIG. 5 is a flowchart pertaining to the settings adjustment processing according to a second preferred embodiment of the present invention.

FIG. 6 is a flowchart pertaining to the settings adjustment processing according to a third preferred embodiment of the present invention.

### DETAILED DESCRIPTION OF THE PREFERRED EMBODIMENTS

Preferred embodiments of the present invention will be described by describing each of first through third preferred embodiments as an example.

### First Preferred Embodiment

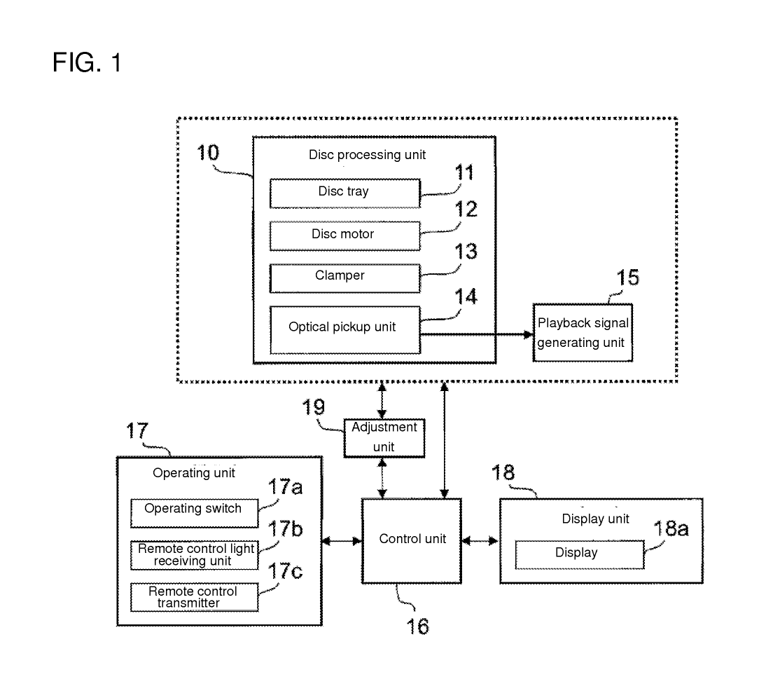

FIG. 1 is a block diagram pertaining to the configuration of an optical disc device 1 according to a preferred embodiment of the present invention. The optical disc device 1 is equipped with a disc processing unit 10, a playback signal generating unit 15, a control unit 16, an operating unit 17, a display unit 18, an adjustment unit 19, and so on as shown in this figure.

The disc processing unit 10 includes a disc tray 11, a disc motor 12, a clamper 13, an optical pickup unit 14, and so forth.

The disc tray 11 is configured to allow a user to set an optical disc (for example, a CD or DVD). To explain this in more concrete terms, the disc tray 11 is installed on the front side of a case (not shown) and configured such that it can move in the open/close direction. When the disc tray 11 is in the open state (a state in which it is extended from the case), the user can set an optical disc 2 in the disc tray 11.

The disc motor 12 (spindle motor) is a motor that drives rotation of the optical disc 2. The clamper 13 serves the role of clamping the optical disc 2 to the disc motor 12 by pressing the optical disc onto the disc motor 12.

When the disc tray 11 in which the optical disc 2 is set is in the closed state (a state in which it is housed within the case), the optical disc 2 is clamped, and the optical disc device 1 can then start spin-up processing. Note that the optical disc device 1 may also be set up so as to automatically perform an operation which executes the clamping and then starts spin-up processing when the disc tray 11 in which the optical disc 2 is set is placed in the closed state.

The optical pickup unit 14 reads information (image information, etc.) recorded on the optical disc 2 according to instructions from the control unit 16 and sends it to later stages. Note that the configuration of the optical pickup unit 14 will be described later in detail.

The playback signal generating unit 15 receives information sent from the optical pickup unit 14 and generates a playback signal for playing this information. The generated playback signal is output to external equipment (such as image display devices), for example, and used to play information recorded on the optical disc 2. Note that the optical disc device 1 may itself be equipped with an image display device or the like so as to display playback images or the like.

The control unit 16 preferably includes a CPU, for example, and is configured and programmed to control various components of the optical disc device 1 such that the optical disc device 1 operates appropriately.

The operating unit 17, as shown in FIG. 1, includes operating switches 17a provided on a case (not shown) and a remote control device (which includes a remote control light-receiving unit 17b and the remote control transmitter 17c) and accepts user operations. The contents of the operations performed by the user are relayed to the control unit 16. As a result, user's intentions are reflected in the operation of the optical disc device 1.

The display unit 18, as shown in FIG. 1, includes a display 18a provided on the case (not shown) and performs simple displays of information such as the current time and the playback status.

The adjustment unit 19 is configured to adjust various settings pertaining to playback of the optical disc 2. For example, the adjustment unit 19 is configured to perform the settings adjustment processing when spin-up processing starts. This settings adjustment processing is a series of processes performed to adjust various settings pertaining to playback of the optical disc 2; the specific contents of the settings adjustment processing will be described later in detail.

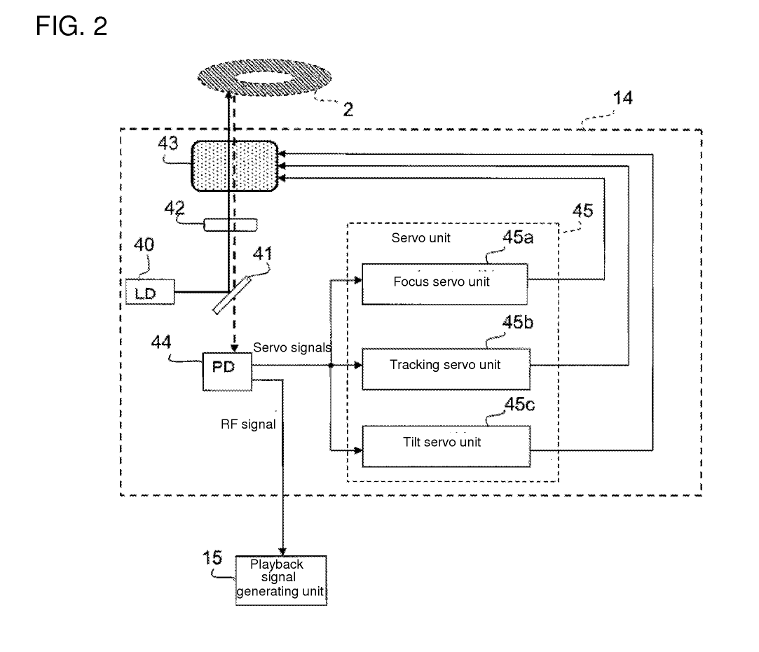

Next, the configuration of the optical pickup unit 14 and its periphery will be described with reference to FIG. 2. The optical pickup unit 14 is equipped with a laser diode 40, a beam splitter 41, a beam expander 42, a lens actuator 43, a photodiode 44, and a servo unit 45.

The laser diode 40 is configured so as to output laser light. The beam splitter 41 is disposed so as to guide laser light output from the laser diode 40 to the optical disc 2, which has been already set in place. Furthermore, the beam expander 42 and the lens actuator 43 are disposed between the beam splitter 41 and the optical disc 2.

The beam expander 42 is a component that expands the radius of the laser light. The beam expander 42 preferably includes a concave lens and a convex lens, and when spherical aberration is generated due to error in the thickness of the optical disc 2, for example, the beam expander 42 is configured to operate so as to correct this aberration by driving the convex lens.

The lens actuator 43 includes an objective lens that concentrates laser light on the information recording surface of the optical disc 2 and enables this objective lens to be driven. The laser light output from the beam splitter 41 hits the optical disc 2 via this objective lens and is reflected. The optical disc 2 thus produces a light spot caused by the laser light.

The photodiode 44 detects laser light reflected after hitting the optical disc 2 (reflected light). The photodiode 44 is disposed at a position where the reflected light is incident and generates an electrical signal according to the intensity of the reflected light.

Examples of the electrical signals generated by the photodiode 44 include RF signals that express the recorded information of the optical disc 2 and servo signals used by various servos. RF signals are sent to the playback signal generating unit 15, and servo signals are sent to the servo unit 45. Note that RF signals are also used when performing setting adjustment operations (described below), in addition to the playback of the optical disc 2.

The servo unit 45 includes a focus servo unit 45a, a tracking servo unit 45b, and a tilt servo unit 45c, and is configured and programmed to perform servo control of objective lenses.

The focus servo unit 45a detects focus error (shift in the focus direction of the light spot) based on servo signals and performs focus servos (so as to make focus error become zero, for example) based on these detection results. Focus servos are controls that modulate the position of the objective lens in the focus direction such that laser light is concentrated onto the surface of the optical disc 2.

The tracking servo unit 45b detects tracking error (shift in the tracking direction of the light spot) based on servo signals and performs tracking servos (so as to make tracking error become zero, for example) based on these detection results. Tracking servos are controls that modulate the position of the objective lens in the tracking direction such that the light spot follows the information track of the optical disc 2. Note that the push/pull method, the differential push/pull method, and the like, for example, are preferably used as the method for generating the tracking error signal.

The tilt servo unit 45c detects tilt error (shift in the tilt direction of the light spot) based on servo signals and performs tilt servos (so as to make tilt error become zero, for example) based on these detection results. Tilt servos are controls that modulate the angle (tilt) of the inclination of the objective lens such that laser light is directed at right angles onto the surface of the optical disc 2.

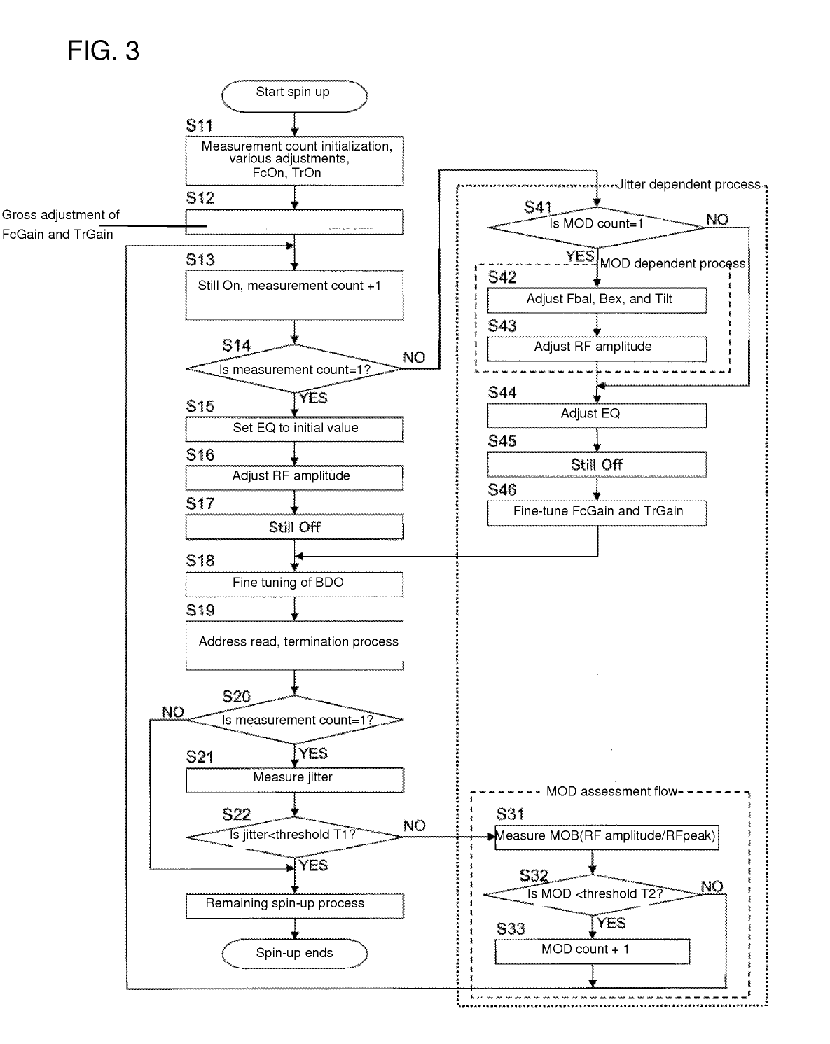

As was described previously, the adjustment unit 19 performs the settings adjustment processing to adjust various settings pertaining to the playback quality of the optical disc 2 (steps S11 through S46 described below) as spin-up processing starts. The specific details of this settings adjustment processing will be described below with reference to the flowchart shown in FIG. 3.

The adjustment unit 19 performs various adjustments while initializing the measurement count and ensures that focus on (FcOn) and tracking on (TrOn) are performed (step S11). Note that this measurement count is a count value which affects the flow of the settings adjustment processing. The significance thereof will become clear from the description that follows. The measurement count is set to “0” when it is initialized.

Next, the adjustment unit 19 performs gross adjustment of the focus gain (FcGain) and tracking gain (TrGain) (step S12). Moreover, the adjustment unit 19 increments the measurement count by 1 with the optical pickup unit 14 in the Still-On state (a state in which the light spot stays on a single track, for example, for adjustments that use the RF signal) (step S13).

Next, the adjustment unit 19 determines whether or not the measurement count is “1” (step S14). If it determines that the measurement count is “1” (YES in step S14), the adjustment unit 19 performs initialization of the equalizer (EQ) (step S15). The initialization of the equalizer is an operation that sets the set value for the equalizer processing that is performed on the RF signal (the equalizer adjustment value) to a predetermined initial value.

Next, the adjustment unit 19 performs adjustment on the amplitude of the RF signal (step S16). This amplitude adjustment is achieved by controlling the gain of the RF signal such that the amplitude of the RF signal stays within the specified tolerance, for example. Thereafter, the adjustment unit 19 places the optical pickup unit 14 in the Still-Off state (the state after leaving the Still-On state) (step S17).

Next, the adjustment unit 19 performs Black Drop Out (BDO) fine-tuning (step S18). Note that, in the disc device 1, when the photodiode 44 includes a quartering photodiode, for example, a signal that adds the outputs of this photodiode (A, B, C, and D signals) can be the signal used for the tracking servo.

This signal has a virtually constant amplitude if the status of the optical disc 2 is good, but it becomes weaker if there are scratches and the like on the optical disc 2. The disc device 1 can use this principle to detect scratches on the optical disc 2 by comparing the amplitude of this signal to a threshold value. The adjustment of BDO described above is an operation that adjusts this threshold value as appropriate, for example, to ensure that this scratch detection is performed with good precision.

Next, the adjustment unit 19 performs the specified address read and termination processing (step S19) and then determines whether or not the measurement count is “1” (step S20). If it determines that the measurement count is “1” (YES in step S20), the adjustment unit 19 performs measurement of jitter in the RF signal (hereinafter also referred to simply as “jitter”) (step S21).

In addition, the adjustment unit 19 determines whether or not the measured jitter is below a specified threshold T1 (step S22). If the jitter is determined to be below the threshold (YES in step S22), the optical disc device 1 is deemed to have already been in a state in which the necessary playback quality can be obtained, and the current settings adjustment processing ends.

Furthermore, if the measurement count is determined not to be “1” in the processing of step S20 (NO in step S20), the processing of steps S21 and S22 is skipped, and the current settings adjustment processing ends. After the settings adjustment processing ends, the remaining processes of the spin-up processing are performed, and the spin-up processing ends.

Note that the optical disc device 1 may also be set such that playback of the optical disc 2 starts upon completion of spin-up processing. This enables the optical disc device 1 to start the playback of the optical disc 2 promptly and automatically after the spin-up processing ends.

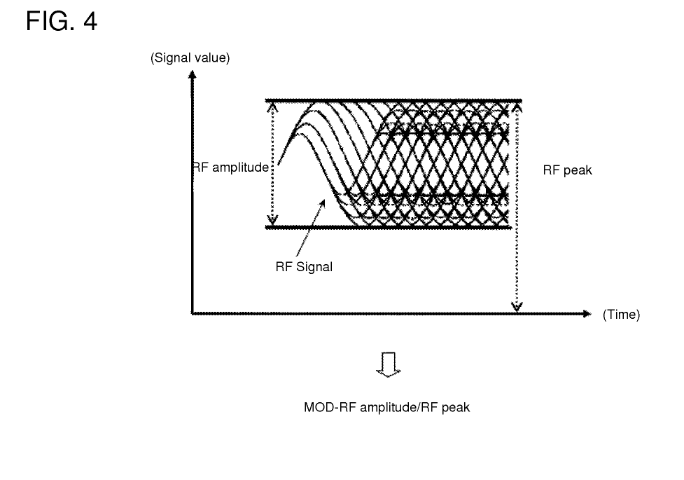

Meanwhile, if the measured jitter is determined not to be below the threshold T1 in the processing of step S22 (NO in step S22), the adjustment unit 19 performs MOD (modulation) measurement (step S31). MOD is the ratio of the RF amplitude to the RF peak (MOD=RF amplitude/RF peak). FIG. 4 shows a conceptual diagram of an RF signal to which is appended an explanation of RF amplitude and RF peak. As shown in this figure, the RF amplitude corresponds to the width of the oscillation of the RF signal, and the RF peak corresponds to the peak in the absolute value of the RF signal.

The adjustment unit 19 then determines whether or not MOD is below a specified threshold T2 (step S32). If MOD is determined to be below the threshold T2 (YES in step S32), the adjustment unit 19 increments the MOD count by 1 (step S33) and performs the processes from step S13 on again.

Meanwhile, if MOD is determined not to be below the threshold T2 in the processing of step S32 (NO in step S32), the adjustment unit 19 skips the processing of step S33 and performs the processes from step S13 on again. Note that the MOD count is a count value which affects the flow of the settings adjustment processing. The significance thereof will become clear in the explanation below. The MOD count is set to “0” when the settings adjustment processing begins.

If the measurement count is determined not to be “1” in the processing of step S14 (NO in step S14), the adjustment unit 19 determines whether or not the MOD count is “1” (step S41). If the MOD count is determined to be “1” (YES in step S41), the adjustment unit 19 performs adjustment of the focus balance (Fbal), adjustment of the beam expander 42 (Bex), and adjustment of the tilt (Tilt) (step S42). Then, the adjustment unit 19 also performs amplitude adjustment on the RF signal (step S43).

Thereafter, the adjustment unit 19 performs equalizer adjustment (for example, processing that optimizes the equalizer adjustment value described previously) (step S44). Note that if the MOD count is determined not to be “1” in the processing of step S41 (NO in step S41), the adjustment unit 19 skips execution of the processing of steps S42 and S43 and performs the processing of step S44.

Next, the adjustment unit 19 places the optical pickup unit 14 in the Still-Off state (step S45) and performs focus gain and tracking gain fine-tuning (step S46). The adjustment unit 19 then performs the processes from step S18 on.

Note that the overall flow of the settings adjustment processing preferably is as described above, but the pattern of the flow that is actually performed preferably falls into one of three patterns, first through third, depending on the results of measuring jitter and MOD while performing the settings adjustment processing. These patterns will be described in order below.

The first pattern is a pattern for the case when the measured value for jitter is determined to be below the threshold T1 in the processing of step S22. In the case of the first pattern, the processes of steps S11 through S22 are performed in order as the settings adjustment processing.

The second pattern is a pattern for the case when the measured value for jitter is determined not to be below the threshold T1 in the processing of step S22 and the measured value for MOD is determined to fall below the threshold T2 in the processing of step S32. In the case of the second pattern, the settings adjustment processing is executed as follows: steps S11 through S22, followed by steps S31 through S33, steps S13 and S14, steps S41 through S46, and steps S18 through S20, in that order.

The third pattern is a pattern for the case when the measured value for jitter is determined not to be below the threshold T1 in the processing of step S22 and the measured value for MOD is determined not to be below the threshold T2 in the processing of step S32. In the case of the third pattern, the settings adjustment processing is executed as follows: steps S11 through S22, followed by steps S31 and S32, steps S13 and S14, step S41, steps S44 through S46, and steps S18 through S20, in that order.

As is clear from this, the execution of part of the settings adjustment processing is omitted (skipped) depending on the measurement results for jitter and MOD while the settings adjustment processing is being executed.

To explain this in greater detail, the processes of steps S31 through S33 and steps S41 through S46 are processes that may or may not be executed, depending on the measurement results for jitter (jitter-dependent processes). Likewise, the processes of steps S42 and S43 are processes that may or may not be executed, depending on the measurement results for MOD (MOD-dependent processes).

Moreover, when the measured value for jitter is determined to fall below the threshold T1 (YES in step S22), execution of the jitter-dependent processes (which also include MOD-dependent processes in the present preferred embodiment) is skipped. In addition, even if jitter-dependent processes are executed, when the measured value for MOD is determined not to fall below the threshold T2 (NO in step S32), execution of MOD-dependent processes is skipped.

Note that jitter and MOD are both evaluation items that are correlated to the playback quality of the optical disc 2; the smaller the jitter value, the better the playback quality tends to be, while the larger the MOD value, the better the playback quality tends to be. Furthermore, jitter serves as an indicator of whether or not it is necessary to execute jitter-dependent processes, while MOD serves as an indicator of whether or not it is necessary to execute MOD-dependent processes.

When the jitter value is good (falls below the threshold T1), it is possible to obtain the required playback quality without having to execute jitter-dependent processes, so the execution of jitter-dependent processes is expected to be unnecessary. Note that even when the jitter value is not good (does not fall below the threshold T1), jitter is expected to be improved by performing jitter-dependent processes thereafter.

Likewise, when the MOD value is good (does not fall below the threshold T2), it is possible to obtain the required playback quality without having to execute MOD-dependent processes, so the execution of MOD-dependent processes is expected to be unnecessary. Note that even when the MOD value is not good (falls below the threshold T2), MOD is expected to be improved by performing MOD-dependent processes thereafter.

The optical disc device 1 uses this principle to skip the execution of the jitter-dependent processes that are unnecessary when the jitter value falls below the threshold T1 and to skip the execution of the MOD-dependent processes that are unnecessary when the MOD value does not fall below the threshold T2. Thus, the optical disc device 1 is designed to identify in detail processes that are unnecessary in the settings adjustment processing in terms of a plurality of evaluation items and to omit the execution thereof.

As a result, the optical disc device 1 reduces the amount of standby time until playback as much as possible. Note that although there are differences depending on the type of the optical disc 2 and other factors, when execution of jitter-dependent processes is skipped, it is expected that the time required between placing an optical disc 2 in the tray to playback is reduced by approximately 15% to 25%, for example.

Note that, in a sense, the value of MOD is also dependent on the adjustment status of the optical pickup unit 14, so it can serve as an indicator for evaluating this adjustment status. For this reason, when the measured value of jitter is not good, it is possible to determine whether or not one of the primary reasons for it lies in the adjustment status of the optical pickup unit 14 by measuring MOD. Moreover, when it is ascertained that the MOD value is not below the threshold T2, it can be determined that adjustment of the optical pickup unit 14 is basically unnecessary to achieve the required playback quality for the optical disc 2.

In the present preferred embodiment, furthermore, the processes of steps S31 through S33 pertaining to MOD assessment (the MOD assessment flow) are also included within the jitter-dependent processes. Based on this, the optical disc device 1 is configured such that when execution of jitter-dependent processes is skipped, execution of the processes of the MOD assessment flow (including the measurement of the MOD value) which becomes unnecessary is also skipped.

Note that the threshold T1 for jitter is an important value that determines whether or not to skip execution of jitter-dependent processes, and it is set to a predetermined appropriate value by a specified method. Examples of methods for determining the threshold T1 include a method in which the threshold T1 is determined using the jitter value stipulated by optical disc standards as a reference and a method in which the threshold T1 is determined after statistically finding jitter values that allow playback using actual drives and optical discs.

In addition, the threshold T2 for MOD is an important value that determines whether or not to skip execution of MOD-dependent processes, and it is set to a predetermined appropriate value by a specified method. Examples of methods for determining the threshold T2 include a method in which the threshold T2 is determined using the recommended MOD for each optical disc recorded as LPP information as a reference and a method in which the threshold T2 is determined after statistically finding the MOD value during playback using actual drives and optical discs.

### Second Preferred Embodiment

Next, a second preferred embodiment of the present invention will be described. Note that the second preferred embodiment is basically the same as the first preferred embodiment except for the aspect pertaining to the settings adjustment processing. In the following description, focus will be placed on the description of the portion different from the first preferred embodiment, and the description of the common portion may be omitted.

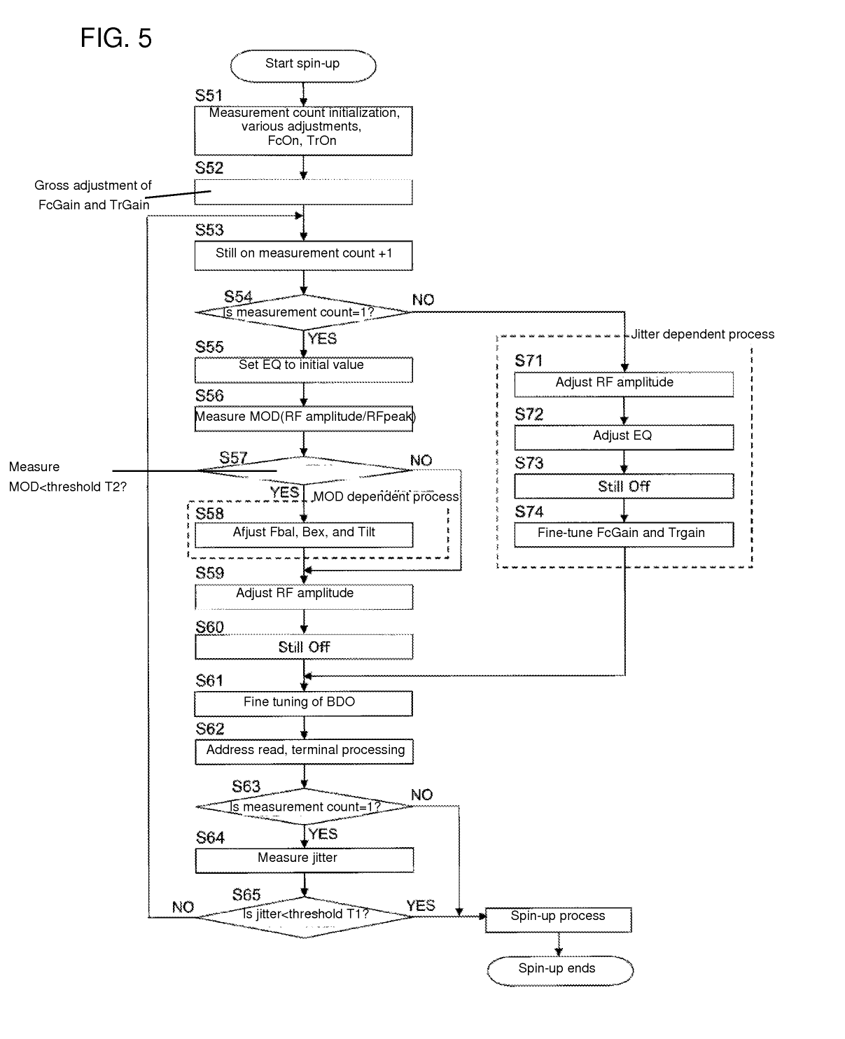

The adjustment unit 19 performs the settings adjustment processing for adjusting various settings pertaining to the playback quality of the optical disc 2 (steps S51 through S74 described below) as spin-up processing starts. The specific details of this settings adjustment processing will be described below with reference to the flowchart shown in FIG. 5.

The adjustment unit 19 performs various adjustments while initializing the measurement count and ensures that focus on (FcOn) and tracking on (TrOn) are performed (step S51). Next, the adjustment unit 19 performs gross adjustment of the focus gain (FcGain) and tracking gain (TrGain) (step S52). Furthermore, the adjustment unit 19 increments the measurement count by 1 with the optical pickup unit 14 in the Still-On state (step S53).

Next, the adjustment unit 19 determines whether or not the measurement count is “1” (step S54). If the measurement count is determined to be “1” (YES in step S54), the adjustment unit 19 performs initialization of the equalizer (EQ) (step S55).

Next, the adjustment unit 19 performs measurement of MOD (=RF amplitude/RF peak) (step S56). The adjustment unit 19 then determines whether or not MOD is below the threshold T2 (step S57). If MOD is determined to be below the threshold (YES in step S57), the adjustment unit 19 performs adjustment of the focus balance (Fbal), adjustment of the beam expander 42 (Bex), and adjustment of the tilt (Tilt) (step S58).

Thereafter, the adjustment unit 19 performs adjustment on the amplitude of the RF signal (step S59). Note that if MOD is determined not to be below the threshold in the processing of step S57 (NO in step S57), the adjustment unit 19 skips execution of the processing of step S58 and performs the processing of step S59.

Next, the adjustment unit 19 places the optical pickup unit 14 in the Still-Off state (step S60) and performs BDO fine-tuning (step S61). Then, the adjustment unit 19 performs the specified address read and termination processing (step S62) and then determines whether or not the measurement count is “1” (step S63).

If the measurement count is determined to be “1” (YES in step S63), the adjustment unit 19 performs jitter measurement (step S64). The adjustment unit 19 then determines whether or not the measured jitter is below the threshold T1 (step S65). If it is determined to be below the threshold (YES in step S65), the optical disc device 1 is deemed to have already been in a state in which the necessary playback quality can be obtained, and the current settings adjustment processing ends.

Moreover, if the measurement count is determined not to be “1” in the processing of step S63 (NO in step S63), then the processing of steps S64 and S65 is skipped, and the current settings adjustment processing ends. After the settings adjustment processing ends, the remaining processes of the spin-up processing are performed, and the spin-up processing ends.

Meanwhile, if the measured jitter is determined to be at or above the threshold in the processing of step S65 (NO in step S65), the adjustment unit 19 performs the processes from step S53 on again. In addition, if the measurement count is determined not to be “1” in the processing of step S54 (NO in step S54), the adjustment unit 19 performs amplitude adjustment on the RF signal (step S71).

Next, the adjustment unit 19 performs equalizer adjustment (step S72) and places the optical pickup unit 14 in the Still-Off state (step S73). Thereafter, the adjustment unit 19 performs fine-tuning of the focus gain and tracking gain (step S74). The adjustment unit 19 then performs the processes from step S61 on.

In the second preferred embodiment as well, the execution of part of the settings adjustment processing is omitted depending on the measurement results for jitter and MOD during execution of the settings adjustment processing.

To explain this in greater detail, the processes of steps S71 through S74 are processes that may or may not be executed, depending on the measurement result for jitter (jitter-dependent processes). Likewise, the process of step S58 is a process that may or may not be executed, depending on the measurement result for MOD (MOD-dependent process).

Then, when the measured value for jitter is determined to fall below the threshold T1 (YES in step S65), execution of the jitter-dependent processes is skipped. Furthermore, when the measured value for MOD is determined not to fall below the threshold T2 (NO in step S57), execution of the MOD-dependent process is skipped.

In the second preferred embodiment as well, the execution of the jitter-dependent processes that are unnecessary is skipped when the jitter value falls below the threshold T1, and execution of the MOD-dependent process that is unnecessary is skipped when the MOD value does not fall below the threshold T2. Thus, the optical disc device 1 is designed to identify in detail processes that are unnecessary in the settings adjustment processing in terms of a plurality of evaluation items and to omit the execution thereof. As a result, the optical disc device 1 reduces the amount of standby time until playback as much as possible.

### Third Preferred Embodiment

Next, a third preferred embodiment of the present invention will be described. Note that the third preferred embodiment is basically the same as the first preferred embodiment except for the aspect pertaining to the settings adjustment processing. In the following description, focus will be placed on the description of the portion different from the first preferred embodiment, and the description of the common portion may be omitted.

In the first preferred embodiment described previously, when it was determined in the processing of step S22 that the measured value of jitter did not fall below the threshold T1 (jitter was not good), the jitter-dependent processes preferably were subsequently executed until the end. However, it is possible that jitter is improved partway through the jitter-dependent processes, and in such cases, it is determined that there is no problem in terminating the settings adjustment processing at the stage where jitter is improved.

If the settings adjustment processing is terminated in this manner at the stage where jitter is improved, the standby time until playback, or the like, is reduced compared to executing the jitter-dependent processes to their conclusion. In particular, if the settings adjustment processing is terminated prior to executing adjustments that require large amounts of time (for example, adjustment of the beam expander 42), the effect is considered very significant.

In light of this, the optical disc device 1 of the third preferred embodiment is configured such that jitter is measured again during execution of jitter-dependent processes, and if this measured value is determined to fall below the threshold T1 (if jitter is determined to have been improved), then the settings adjustment processing is terminated.

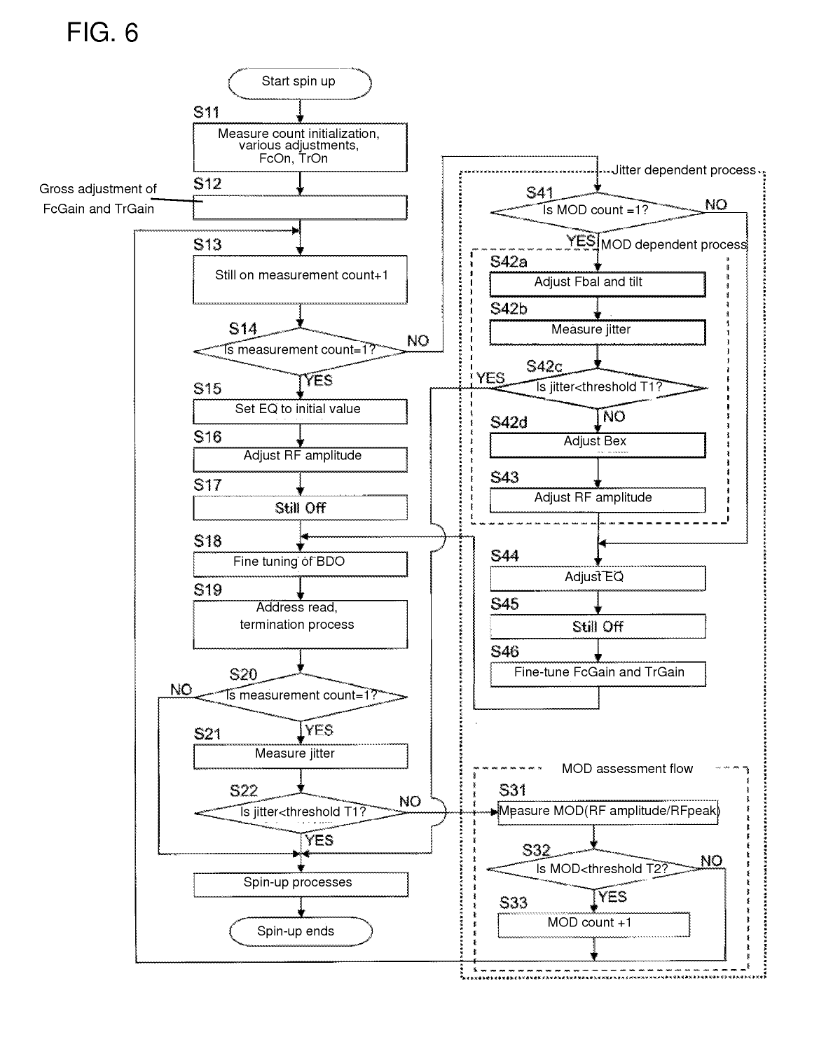

The settings adjustment processing performed by the optical disc device 1 of the third preferred embodiment will be described below with reference to the flowchart shown in FIG. 6. Note that the settings adjustment processing of the third preferred embodiment differs from that of the first preferred embodiment in that the processing of steps S42a through S42d is performed in place of the processing of step S42. This difference will be described below.

If the MOD count is determined to be “1” in the processing of step S41 (YES in step S41), the adjustment unit 19 performs adjustment of the focus balance (Fbal) and adjustment of the tilt (Tilt) (step S42a). Next, the adjustment unit 19 performs jitter measurement (step S42b).

Moreover, the adjustment unit 19 determines whether or not the current jitter measurement value is below the threshold T1 (step S42c). If it is determined to be below the threshold (YES in step S42c), then the optical disc device 1 is deemed to have already been in a state in which the required playback quality can be obtained, and the current settings adjustment processing ends. Thereafter, the remaining processes of the spin-up processing are performed, and the spin-up processing ends.

Meanwhile, if the measured jitter is determined to be at or above the threshold in the processing of step S42c (NO in step S42c), the adjustment unit 19 performs adjustment on the beam expander 42 (Bex) (step S42d). Thereafter, the adjustment unit 19 performs the processes from step S43 on.

With the settings adjustment processing of the third preferred embodiment, if it is determined that jitter has been improved by the assessment processing for jitter (step S42c) during the jitter-dependent processes, processes from step S42d and beyond are omitted. This enables the settings adjustment processing to be concluded earlier to the extent that processes from step S42d and beyond are omitted.

Note that the timing at which such assessment processing for jitter is performed is not limited to immediately after the execution of the processing of step S42a as in the present preferred embodiment, and it can be performed with various timing. In addition, such assessment processing for jitter may also be performed not just once as in the present preferred embodiment but two or more times, as necessary.

As was described above, the optical disc device 1 according to each of the preferred embodiments preferably includes an optical pickup unit 14 that irradiates an optical disc 2 with light and generates an RF signal according to the reflected light from the optical disc 2 and a functional unit (playback unit) that uses the RF signal to perform playback of the optical disc 2. Furthermore, the optical disc device 1 preferably includes a functional unit (adjustment unit) that performs settings adjustment processing that includes jitter-dependent processes (first adjustment processes) and MOD-dependent processes (second adjustment processes) as a series of processes that adjusts various settings pertaining to the playback quality of the optical disc 2.

This adjustment unit measures the respective values of jitter (first evaluation item), which serves as an indicator of whether or not it is necessary to perform jitter-dependent processes, and MOD (second evaluation item), which serves as an indicator of whether or not it is necessary to perform MOD-dependent processes, among the evaluation items that are correlated to the playback quality. Moreover, the adjustment unit skips execution of the jitter-dependent processes when the measured jitter value is below a threshold (according to the results of jitter value measurement) and skips execution of the MOD-dependent processes when the measured MOD value is not below a threshold (according to the results of MOD value measurement).

Therefore, with the optical disc device 1, it is possible to identify in detail processes that are unnecessary in the settings adjustment processing and to omit the execution thereof by focusing on the plurality of evaluation items, i.e., the first evaluation item and the second evaluation item. Note that evaluation items other than the first evaluation item and the second evaluation item may also be adopted so long as they do not depart from the gist of the present invention. For instance, the error rate or the like for RF signals may also be used instead of jitter as the first evaluation item.

In addition, in the first preferred embodiment, the optical disc device 1 executes MOD-dependent processes as part of the jitter-dependent processes, and skips measurement of the MOD value when it omits execution of the jitter-dependent processes. The optical disc device 1 thus prevents execution of wasteful processes to the extent that measurement of the MOD value is omitted.

Furthermore, the optical disc device 1 measures the value of jitter after executing the respective processes (steps S11 through S20) of the settings adjustment processing, excluding jitter-dependent processes and MOD-dependent processes. Because of this, the optical disc device 1 makes it possible to omit execution of jitter-dependent processes when jitter is good after performing these processes.

Moreover, the optical disc device 1 determines whether or not it is necessary to execute jitter-dependent processes based on the measurement results after measuring the jitter value (steps S21 and S22). Then, the optical disc device 1 is configured so as to terminate the settings adjustment processing when it determines that execution is unnecessary. This makes it possible to shorten the time required for the settings adjustment processing, to reduce the standby time until playback as much as possible, and so on.

In addition, for the configuration of the present invention, besides the preferred embodiments, a variety of modifications can be made within the scope that does not depart from the gist of the present invention. That is, the preferred embodiments should be considered to be illustrative examples in all respects and non-restrictive. The technological scope of the present invention is indicated not by the description of the preferred embodiments but rather by the scope of the claims, and it should be understood to include all modifications with an equivalent meaning to and within the scope of the claims. Furthermore, preferred embodiments of the present invention can be utilized in optical disc devices or the like that perform processing pertaining to optical discs.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An optical disc device comprising:
an optical pickup unit configured to irradiate an optical disc with light and generate a signal according to the light reflected from the optical disc;
a playback unit configured to use the signal to execute playback of the optical disc; and
an adjustment unit configured to execute settings adjustment processing that includes a first adjustment process and a second adjustment process as a series of processes to adjust settings pertaining to playback quality of the optical disc; wherein
the adjustment unit is configured to:
measure, among evaluation items that are correlated to the playback quality, respective values of a first evaluation item that is an indicator of whether or not it is necessary to execute the first adjustment process and a second evaluation item that is an indicator of whether or not it is necessary to execute the second adjustment process;
omit execution of the first adjustment process depending on a result of measuring the value of the first evaluation item; and
omit execution of the second adjustment process depending on a result of measuring the value of the second evaluation item.

2. The optical disc device according to claim 1, wherein the adjustment unit is configured to execute the second adjustment process as part of the first adjustment process and omit measurement of the value of the second evaluation item when execution of the first adjustment process is omitted.

3. The optical disc device according to claim 2, wherein the adjustment unit is configured to measure the value of the first evaluation item after performing the respective processes of the settings adjustment processing excluding the first adjustment process and the second adjustment process.

4. The optical disc device according to claim 3, wherein the adjustment unit is configured to measure the value of the first evaluation item and then determine whether or not it is necessary to execute the first adjustment process based on the results of the measurement, and when it is determined that execution is not necessary, terminate the settings adjustment processing.

5. The optical disc device according to claim 1, wherein the first evaluation item is jitter in the signal.

6. The optical disc device according to claim 5, wherein the first adjustment process includes at least one of amplitude adjustment of the signal, equalizer adjustment of the signal, focus gain adjustment, and tracking gain adjustment.

7. The optical disc device according to claim 1, wherein the second evaluation item is a ratio of a width of an oscillation of the signal to a peak in an absolute value of the signal.

8. The optical disc device according to claim 7, wherein the second adjustment process includes at least one of focus balance adjustment, beam expander adjustment, and tilt adjustment.

9. The optical disc device according to claim 1, wherein the optical disc device is configured to execute spin-up processing that includes the settings adjustment processing, and the playback unit starts the playback of the optical disc upon the termination of the spin-up processing.

10. The optical disc device according to claim 1, wherein the adjustment unit is configured to perform Black Drop Out fine-tuning.

11. The optical disc device according to claim 1, wherein the adjustment unit is configured to perform modulation measurement of the signal.

12. The optical disc device according to claim 1, wherein the adjustment unit is configured to execute the settings adjustment processing according to one of a plurality of patterns.

13. The optical disc device according to claim 12, wherein the plurality of patterns includes three different patterns.

14. The optical disc device according to claim 5, wherein when a measured value for the jitter is not below a threshold, the adjustment unit performs jitter-dependent processing until completed.

15. The optical disc device according to claim 5, wherein when a measured value for the jitter is below a threshold, the adjustment unit omits jitter-dependent processing.

16. The optical disc device according to claim 5, wherein the jitter is measured during jitter-dependent processing and determine whether a measure value for the jitter is below a threshold.

17. The optical disc device according to claim 11, wherein when a measured value for the modulation is not below a threshold, the adjustment unit performs modulation-dependent processing until completed.

18. The optical disc device according to claim 11, wherein when a measured value for the modulation is below a threshold, the adjustment unit omits modulation-dependent processing.
